(19) United States
(12) Patent Application Publication
(10) Pub. No.: US 2023/0327196 A1
(43) Pub. Date: Oct. 12, 2023

(54) IN-SITU CROSSLINKED GEL POLYMER ELECTROLYTE AND METHOD FOR MANUFACTURING SAME

(71) Applicants: Hyundai Motor Company, Seoil (KR); Kia Corporation, Seoul (KR); Seoul National University R&DB Foundation, Seoul (KR)

(72) Inventors: Eun Ji Kwon, Yongin-si (KR); Won Keun Kim, Seoul (KR); Samuel Seo, Yongin-s (KR); Yeon Jong Oh, Seoul (KR); Kyu Ju Kwak, Hwaseong-si (KR); Kyoung Han Ryu, Yongin-si (KR); Dong Hyun Lee, Seoul (KR); Jong Chan Lee, Seoul (KR); Da Un Jeong, Seoul (KR); Jin Sol Yook, Seoul (KR); Dong Gi Hong, Seoul (KR)

(21) Appl. No.: 17/988,415

(22) Filed: Nov. 16, 2022

(30) Foreign Application Priority Data
Mar. 22, 2022 (KR) 10-2022-0035074

(51) Int. Cl. H01M 10/0565

(52) U.S. Cl. CPC H01M 10/0565; H01M 2300/0082; H01M 2300/0085

(57) ABSTRACT

A gel polymer electrolyte manufactured through an in-situ crosslinking reaction. The gel polymer electrolyte may include a porous membrane in which a fluorine-based compound, a lithium salt, and a crosslinking agent including a graphene-based compound are crosslinked.

### CROSS-REFERENCE TO RELATED APPLICATION

This application claims under 35 U.S.C. §119(a) the benefit of priority to Korean Patent Application No. 10-2022-0035074 filed on Mar. 22, 2022, the entire contents of which are incorporated herein by reference.

### BACKGROUND

### (A) Technical Field

The present disclosure relates to a gel polymer electrolyte manufactured through an in-situ crosslinking reaction.

### (B) Discussion of The Background

Lithium secondary batteries may be applied to various fields and devices, such as portable electronic devices, and automobiles. Since conventional lithium secondary batteries use liquid electrolytes, they have certain disadvantages such as risks of leakage and explosion, and the battery design of such batteries is complicated due to countermeasures therefor.

An application of a polymer electrolyte is under research to address problems such as leakage and explosion and to manufacture a battery in a desired shape (e.g., with a smaller size or a thin film type).

However, solid-phase polymer electrolytes have significantly lower lithium ion conductivity than liquid electrolytes so that they may not yet be suitable for commercialization. Therefore, there is a need for a material that exhibits high lithium ion conductivity while maintaining a solid phase.

### SUMMARY

The following summary presents a simplified summary of certain features. The summary is not an extensive overview and is not intended to identify key or critical elements.

An object of the present disclosure is to provide a gel polymer electrolyte exhibiting higher lithium ion conductivity at room temperature.

The objects of the present disclosure are not limited to the object mentioned above. The objects of the present disclosure will become clearer from the following description, and will be realized by means and combinations thereof described in the claims.

A composition for a gel polymer electrolyte may include: a fluorine-based compound; a lithium salt; and a crosslinking agent including a graphene-based compound.

The composition may further include at least one initiator selected from the group consisting of benzoyl peroxide, acetyl peroxide, dilauroyl peroxide, di-tert-butyl peroxide, t-butyl peroxy-2-ethylhexanoate, cumyl hydroperoxide, hydrogen peroxide, 2,2-azobis(2-cyanobutane), 2,2′-azobis(2-methylbutyronitrile), azobisisobutyronitrile (AIBN), azobisdimethyl-valeronitrile (AMVN), and combinations thereof.

A lithium secondary battery according to an embodiment of the present disclosure may include: a cathode layer; an anode layer; and an electrolyte layer interposed between the cathode layer and the anode layer, wherein the electrolyte layer may include a gel polymer electrolyte, and the gel polymer electrolyte may include a porous membrane in which a fluorine-based compound, a lithium salt, and a crosslinking agent including a graphene-based compound are crosslinked.

The fluorine-based compound may include at least one selected from the group consisting of poly(vinylidene fluoride-co-hexafluoropropylene) (PVDF-HFP), a perfluorinated sulfonic acid-based polymer, and a combination thereof.

The lithium salt may include at least one selected from the group consisting of lithium 1-(3-(methacryloyloxy)propylsulfonyl)-1-(trifluoromethanesulfonyl)imide (LiMTFSI), lithium(4-styrenesulfonyl)(trifluoromethanesulfonyl)imide (LiSTFSI), and a combination thereof.

The crosslinking agent may include a graphene oxide surface-modified with methacrylate.

The fluorine-based compound and the lithium salt may have a mass ratio of about 1:0.1 to 1:10.

The gel polymer electrolyte may include: an amount of more than about 98% by weight and less than about 100% by weight of the fluorine-based compound and lithium salt; and an amount of more than about 0% by weight and less than about 2% by weight of the crosslinking agent.

The electrolyte layer may further include a liquid electrolyte impregnated in the gel polymer electrolyte.

A method for manufacturing a gel polymer electrolyte according to an embodiment of the present disclosure may include: preparing a solution containing a fluorine-based compound, a lithium salt, and a crosslinking agent including a graphene-based compound; preparing a reactant by adding an initiator into the solution; and applying the reactant onto a substrate and performing in-situ crosslinking.

According to the present disclosure, the gel polymer electrolyte exhibiting high lithium ion conductivity at room temperature can be obtained.

The effects of the present disclosure are not limited to the above-mentioned effect. It should be understood that the effects of the present disclosure include all effects that can be inferred from the following description.

### BRIEF DESCRIPTION OF THE DRAWINGS

FIG. 1 shows a cross-sectional view of an example battery.

FIG. 2 shows an analysis result of the surface of the gel polymer electrolyte according to Example 2 using a scanning electron microscope (SEM).

FIG. 3 shows galvanostatic cycling voltage profiles of the respective symmetrical cells according to Experimental Example 3.

FIG. 4 shows discharge capacities and coulombic efficiencies of the respective lithium metal batteries according to Experimental Example 4.

FIG. 5 shows C rate capacity test results for discharge capacities of the respective lithium metal batteries according to Experimental Example 4.

FIG. 6 shows a result of evaluating capacity properties of a lithium metal battery to which the gel polymer electrolyte according to Example 2 is introduced.

FIG. 7 shows a result of evaluating capacity properties of a lithium metal battery to which a commercially available electrolyte layer is introduced.

### DETAILED DESCRIPTION

The above objects, other objects, features and advantages of the present disclosure will be easily understood through the following examples related to the accompanying drawings. However, aspects of the present disclosure are not limited to the examples described herein and may be embodied in other forms. Rather, various examples described herein are provided so that the disclosed content may become thorough and complete, and the spirit of the present disclosure may be sufficiently conveyed to those skilled in the art.

In the present specification, terms such as “comprise”, “have”, etc. are intended to designate that a feature, number, step, operation, component, part, or a combination thereof described in the specification exists, but it should be understood that the terms do not preclude the possibility of the existence or addition of one or more other features, numbers, steps, operations, components, parts, or combinations thereof. Further, when a part of a layer, film, region, plate, etc. is said to be “on” other part, this includes not only the case where it is “directly on” the other part but also the case where there is another part in the middle thereof. Conversely, when a part of a layer, film, region, plate, etc. is said to be “under” other part, this includes not only the case where it is “directly under” the other part, but also the case where there is another part in the middle thereof.

Unless otherwise specified, since all numbers, values, and/or expressions expressing quantities of components, reaction conditions, polymer compositions and formulations used in the present specification are approximate values reflecting various uncertainties of the measurement that arise in obtaining these values among others in which these numbers are essentially different, they should be understood as being modified by the term “about” in all cases. Further, when a numerical range is disclosed in this description, such a range is continuous, and includes all values from a minimum value of such a range to a maximum value including the maximum value, unless otherwise indicated. Furthermore, when such a range refers to an integer, all integers including from a minimum value to a maximum value including the maximum value are included, unless otherwise indicated.

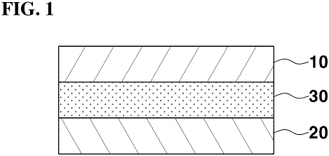

FIG. 1 shows a cross-sectional view of an example battery (e.g., a lithium secondary battery). Referring to this, the battery may include a cathode layer 10, an anode layer 20, and an electrolyte layer 30 between the cathode layer 10 and the anode layer 20.

The cathode layer 10 may include a cathode active material, a binder, a conductive material, and the like.

The cathode active material may include one or more selected from the group consisting of lithium cobalt oxide, lithium nickel cobalt manganese oxide, lithium nickel cobalt aluminum oxide, lithium iron phosphorous oxide, lithium manganese oxide, and combinations thereof. However, the cathode active material is not limited thereto, and any other cathode active material may be used.

The binder may assist in bonding between the cathode active material and the conductive material or the like and bonding to the current collector. The binder may include polyvinylidene fluoride, polyvinyl alcohol, carboxymethyl cellulose (CMC), starch, hydroxypropyl cellulose, regenerated cellulose, polyvinylpyrrolidone, tetrafluoroethylene, polyethylene, polypropylene, ethylene-propylene-diene terpolymer (EPDM), sulfonated EPDM, styrene butadiene rubber, fluoro rubber, various copolymers, etc. However, the binder is not limited thereto, and any other binder may be used.

The conductive material is not particularly limited as long as it has conductivity without causing a significant chemical change in the concerned battery. For example, it may include: graphite such as natural graphite or artificial graphite; carbon-based materials such as carbon black, acetylene black, Ketjen black, channel black, furnace black, lamp black, and summer black; conductive fibers such as carbon fibers and metal fibers; metal powders such as carbon fluoride, aluminum, and nickel powder; conductive whiskers such as zinc oxide and potassium titanate; conductive metal oxides such as titanium oxide; and conductive materials such as polyphenylene derivatives.

The anode layer 20 may include an anode active material, a binder, a conductive material, and the like.

The anode active material may include a carbon active material, a metal active material, and the like. However, the anode active material is not limited thereto, and any other anode active material may be used.

The carbon active material may include graphite such as mesocarbon microbeads (MCMB) and highly oriented pyrolytic graphite (HOPG), and amorphous carbon such as hard carbon and soft carbon.

The metal active material may include at least one of: In, Al, Si, Sn, and/or an alloy containing at least one of these elements.

Since the binder and the conductive material have been described above, further description thereof may be omitted below.

The anode layer 20 may include a lithium metal or a lithium metal alloy.

The lithium metal alloy may include lithium and an alloy of a metal or metalloid capable of alloying with lithium.

The metal or metalloid capable of alloying with lithium may include at least one of: Si, Sn, Al, Ge, Pb, Bi, Sb, or the like.

The electrolyte layer 30 may include a gel polymer electrolyte.

The gel polymer electrolyte may include a porous membrane formed by crosslinking a fluorine-based compound, a lithium salt, and a crosslinking agent. For example, the gel polymer electrolyte may be one obtained by in-situ crosslinking a composition comprising a fluorine-based compound, a lithium salt, and a crosslinking agent.

In one or more examples of the present disclosure, the mechanical properties and lithium ion conductivity of the gel polymer electrolyte are improved by introducing a fluorine-based compound constituting the matrix and a specific crosslinking agent.

Further, in one or more examples of the present disclosure, a gel polymer electrolyte may be capable of being impregnated with more liquid electrolytes by forming a porous membrane through an in-situ crosslinking reaction. Accordingly, the lithium ion conductivity of the electrolyte layer may be further increased.

Further, in one or more examples of the present disclosure, thermal and electrochemical stabilities of the gel polymer electrolyte are improved by introducing a graphene compound as a crosslinking agent.

Since the electrolyte layer 30 may provide excellent mechanical properties, lithium ion conductivity, and electrochemical stability, it may be possible to effectively suppress the formation of lithium dendrites during charging and discharging of a battery.

The fluorine-based compound may constitute a matrix of the electrolyte layer 30. It may also serve as a reinforcing material. The stability of an interface between the electrolyte layer 30 and the anode layer 20 may be improved by introducing the fluorine-based compound.

The fluorine-based compound may include at least one selected from the group consisting of poly(vinylidene fluoride-co-hexafluoropropylene) (PVDF-HFP), a perfluorinated sulfonic acid-based polymer, and/or a combination thereof. The perfluorinated sulfonic acid-based polymer may include, for example, Nafion.

The lithium salt may include lithium cation and anion. The lithium salt may be a type of monomer and be a constituent to be distinguished from the lithium salt of a liquid electrolyte to be described later. The polarization of the battery and the growth of lithium dendrites may be suppressed by using the lithium salt.

The lithium salt may include at least one selected from the group consisting of lithium 1-(3-(methacryloyloxy)propylsulfonyl)-1-(trifluoromethanesulfonyl)imide (LiMTFSI), lithium(4-styrenesulfonyl)(trifluoromethanesulfonyl)imide (LiSTFSI), and/or combinations thereof.

The fluorine-based compound and the lithium salt may have a mass ratio of about 1:0.1 to 1:10, about 1:0.5 to 1:5, or preferably about 1:1. When the mass ratio falls within the above numerical range, mechanical properties and lithium ion conductivity of the gel polymer electrolyte may be improved in a balanced way.

The crosslinking agent may include a graphene-based compound. The mechanical properties of the electrolyte layer 30 may be increased, and growth of lithium dendrites may be suppressed by using a graphene-based compound as the crosslinking agent.

The crosslinking agent may include graphene oxide surface-modified with methacrylate.

The gel polymer electrolyte may include an amount of more than about 98% by weight and less than about 100% by weight, or about 99% by weight to about 99.5% by weight of the fluorine-based compound and lithium salt. The gel polymer electrolyte may include an amount of more than about 0% by weight and less than about 2% by weight, or about 0.5% by weight to about 1% by weight of the crosslinking agent. If the content of the crosslinking agent falls within the above numerical range, mechanical properties, lithium ion conductivity, liquid electrolyte impregnation amount, and the like of the electrolyte layer 30 may be improved in a balanced way.

The electrolyte layer 30 may further include a liquid electrolyte impregnated in the gel polymer electrolyte.

The liquid electrolyte may include an organic solvent and a lithium salt. In one or more examples of the present disclosure, the lithium salt of the liquid electrolyte may be distinguished from the lithium salt used as a monomer of the above-described gel polymer electrolyte.

The organic solvent may include ethylene carbonate, dimethyl carbonate, diethyl carbonate, ethyl methyl carbonate, fluoroethylene carbonate, 1,2-dimethoxyethane, 1,2-diethoxyethane, dimethylene glycol dimethyl ether, trimethylene glycol dimethyl ether, triethylene glycol dimethyl ether, tetraethylene glycol dimethyl ether, polyethylene glycol dimethyl ether, succinonitrile, sulfolane, dimethyl sulfone, ethyl methyl sulfone, diethyl sulfone, adiponitrile, 1,1,2,2-tetrafluoroethyl 2,2,3,3-tetrafluoropropyl ether, dimethylacetamide, and the like.

The lithium salt may include at least one of: LiNO₃, LiPF₆, LiBF₆, LiCIO₄, LiCF₃SO₃, LiBr, Lil, and the like.

However, the type of the liquid electrolyte is not particularly limited, and any one commonly used in the technical field to which the present disclosure pertains or any other liquid electrolyte may be included.

The method for manufacturing a gel polymer electrolyte may include preparing a solution including a fluorine-based compound, a lithium salt, and a crosslinking agent, preparing a reactant by adding an initiator into the solution, and applying the reactant onto a substrate and performing in-situ crosslinking.

Since each constituent of the gel polymer electrolyte has been described above, further description thereof may be omitted below.

The adding timing of the initiator is not particularly limited. For example, it may be added together with the fluorine-based compound or the like, or may be added after preparing the solution.

The initiator may include at least one selected from the group consisting of benzoyl peroxide, acetyl peroxide, dilauroyl peroxide, di-tert-butylperoxide, t-butyl peroxy-2-ethyl-hexanoate, cumyl hydroperoxide, hydrogen peroxide, 2,2-azobis(2-cyanobutane), 2,2′-azobis(2-methylbutyronitrile), azobisisobutyronitrile (AIBN), azobisdimethyl-valeronitrile (AMVN), and/or combinations thereof.

Hereinafter, one or more examples of the present disclosure will be described in more detail with reference to the following Examples and Comparative Examples. However, aspects of the present disclosure are not restricted or limited thereto.

Example 1, Example 2, and Comparative Examples 1 to 5

(Synthesis of crosslinking agent) After dispersing about 0.2 g of graphene oxide in dimethylformamide (DMF) as a solvent by sonication, methacryloyl chloride and triethylamine were added thereinto. The combination was stirred at about 30° C. for about 24 hours and filtered to obtain graphene oxide surface-modified with methacrylate.

(Manufacturing of gel polymer electrolytes) The crosslinking agent was added into N-methyl-2-pyrrolidone (NMP) as a solvent and dispersed it therein by sonication for about 3 hours. Accordingly, poly(vinylidene fluoride-co-hexafluoropropylene) (PVDF-HFP) as a fluorine-based compound, lithium 1-(3-(methacryloyloxy)propylsulfonyl)-1-(trifluoromethanesulfonyl)imide (LiMTFSI) as a lithium salt, and azobisisobutyronitrile (AIBN) as an initiator were added thereinto. Then, it was dispersed by sonication for about 3 hours and cast on a glass plate. The resultant product was subjected to an in-situ cross-linking reaction at about 80° C. under vacuum conditions for 24 hours to obtain a gel polymer electrolyte in the form of a porous membrane. The gel polymer electrolyte was washed with ethanol to remove unreacted lithium salt.

The contents of each component of Example 1, Example 2, and Comparative Examples 1 to 5 are summarized in Table 1 below.

[TABLE 1]

| Category | Composition | | |
|---|---|---|---|
| | Mass ratio of fluorine-based compound and lithium salt | Content of fluorine-based compound and lithium salt | Content of crosslinking agent |
| Comparative Example 1 | 1:1 | 100% by weight | 0% by weight |
| Example 1 | 1:1 | 99.5% by weight | 0.5% by weight |
| Example 2 | 1:1 | 99% by weight | 1% by weight |
| Comparative Example 2 | 1:1 | 98% by weight | 2% by weight |
| Comparative Example 3 | 1:1 | 97% by weight | 3% by weight |
| Comparative Example 4 | 1:1 | 95% by weight | 5% by weight |
| Comparative Example 5 | 1:1 | 90% by weight | 10% by weight |

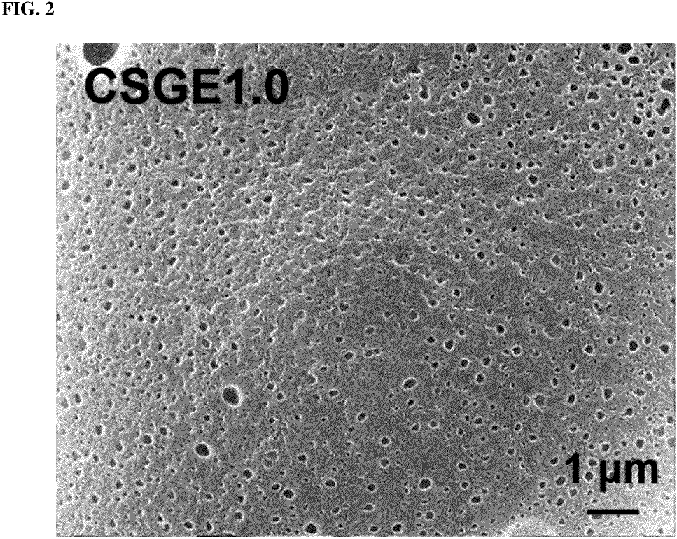

The surface of the gel polymer electrolyte according to Example 2 was analyzed with a scanning electron microscope (SEM). The result is as shown in FIG. 2. Referring to this, it can be seen that the gel polymer electrolyte is formed to be porous.

### Experimental Example 1

The thermal decomposition temperature of each gel polymer electrolyte, and the contact angle and Young’s modulus of the liquid electrolyte were measured. The results are as shown in Table 2 below. Young’s modulus was measured using AFM indentation mode (MFP-3D Classic (Asylum Research-Oxford Instruments) with an indentation depth of 200 nm).

[TABLE 2]

| Category | T_{g1}[°C]^{a)} | T_{g2}[°C]^{b)} | T_{d,5%}[°C]^{c)} | Contact angle[°]^{d)} | Young’s modulus [MPa]^{e)} |
|---|---|---|---|---|---|
| Comparative Example 1 | -39.3 | 145.4 | 298.1 | 47.2 | 116.1 |
| Example 1 | -39.6 | 146.5 | 303.2 | 32.3 | 256.8 |
| Example 2 | -39.3 | 144.8 | 306.1 | 28.7 | 552.2 |
| Comparative Example 2 | -39.4 | 146.4 | 312.5 | 35.8 | 319.0 |
| Comparative Example 3 | -39.6 | 145.3 | 317.7 | 37.8 | 299.7 |
| Comparative Example 4 | -39.2 | 145.4 | 320.5 | 42.1 | 149.0 |
| Comparative Example 5 | -39.3 | 146.4 | 304.0 | 21.5 | 131.9 |

a) Glass transition temperature of the fluorine-based compound
b) Glass transition temperature of the lithium salt
c) The thermal decomposition temperature obtained by thermogravimetric analysis (TGA) and the temperature when the weight loss ratio reached 5% by weight were measured
d) Dropped the liquid electrolyte on the sample and measured the contact angle after 1 second, and the liquid electrolyte was one obtained by adding 1 M LiPF₆ to a mixed solvent of ethylene carbonate and dimethyl carbonate
e) After measuring measurement values a total of three times in AFM indentation mode, the average value thereof was recorded

Referring to Table 2, as the content of the crosslinking agent is increased to 5% by weight, the graphene oxide functions as a radical scavenger and the thermal decomposition temperature increases. When the content of the crosslinking agent is 10% by weight, the thermal decomposition temperature is reduced due to the phase separation of the crosslinking agent.

As the content of the crosslinking agent increases up to 1% by weight, the porosity and crosslinking density of the gel polymer electrolyte increase to decrease the contact angle of the liquid electrolyte. However, when the content of the crosslinking agent is 2% by weight or more, the porosity and crosslinking density of the gel polymer electrolyte decrease due to phase separation of the crosslinking agent to increase the contact angle of the liquid electrolyte.

As the content of the crosslinking agent is increased up to 1% by weight, the crosslinked structure is uniformly formed and the crosslink density is increased to increase Young’s modulus. When the content of the crosslinking agent is 2% by weight or more, the crosslinking density decreases due to phase separation of the crosslinking agent to lower Young’s modulus.

### Experimental Example 2

Each gel polymer electrolyte was impregnated with a liquid electrolyte for about 24 hours, and a coin cell having a spacer/electrolyte layer/spacer structure was assembled using this as an electrolyte layer. The resistance of the coin cell was measured in a temperature range of 10° C. to 80° C., and this was converted into lithium ion conductivity (using Zahner Electrik IM6 equipment, frequency range of 100 Hz to 1 MHz at an applied voltage of 10 mV).

The results are as shown in Table 3 below.

[TABLE 3]

| Category | Impregnation amount of liquid electrolyte [parts by weight]^{a)} | Lithium ion conductivity [S·cm⁻¹]^{b)} | Ratio of dissociated anions^{c)} | EW[V]^{d)} |
|---|---|---|---|---|
| Comparative Example 1 | 268.4 | 4.1×10⁻⁵ | 0.690 | 4.84 |
| Example 1 | 353.1 | 8.0×10⁻⁵ | 0.963 | 4.88 |
| Example 2 | 473.4 | 1.6×10⁻⁴ | 1.090 | 5.07 |
| Comparative Example 2 | 318.8 | 6.5×10⁻⁵ | 0.825 | 5.14 |
| Comparative Example 3 | 311.9 | 5.8×10⁻⁵ | 0.803 | 5.13 |
| Comparative Example 4 | 310.0 | 5.2×10⁻⁵ | 0.797 | 4.94 |
| Comparative Example 5 | 295.1 | 6.5×10⁻⁵ | 0.817 | 4.85 |

a) The impregnation amount of the liquid electrolyte is a value based on 100 parts by weight of the gel polymer electrolyte
b) Measured at 25° C., and the liquid electrolyte included one obtained by adding 1 M LiPF₆ to a mixed solvent of ethylene carbonate and dimethyl carbonate
c) The ratio of MTFSI- dissociated from LiMTFSI as a lithium salt, [MTFSI-]/[Li+MTFSI-], and the intensity of the corresponding peak of Fourier-transform infrared spectroscopy (FT-IR) were measured and calculated
d) Electrochemical window measured by linear sweep voltammetry

Referring to Table 3, as the content of the crosslinking agent increases up to 1% by weight, the porosity and crosslinking density of the gel polymer electrolyte are increased to increase the impregnation amount of the liquid electrolyte. However, when the content of the crosslinking agent is 2% by weight or more, the porosity and crosslinking density of the gel polymer electrolyte are decreased due to phase separation of the crosslinking agent to decrease the impregnation amount of the liquid electrolyte. Since a porous membrane is not properly formed in Comparative Example 1 which does not contain a crosslinking agent, the impregnation amount of the electrolyte is very low, and thus the lithium ion conductivity is the lowest.

As the content of the crosslinking agent increases up to 1.0% by weight, the impregnation amount of the liquid electrolyte is increased, thereby increasing the lithium ion conductivity. However, when the content of the crosslinking agent is 2% by weight or more, the impregnation amount of the liquid electrolyte is reduced to lower the lithium ion conductivity.

As the content of the crosslinking agent increases up to 1.0% by weight, the porosity and crosslinking density of the gel polymer electrolyte are increased to increase the impregnation amount of the liquid electrolyte so that the ratio of dissociated MTFSI- anions is increased.

It can be seen that all samples are stable up to 4.5 V regardless of the content of the crosslinking agent.

### Experimental Example 3

A Li/Li symmetric cell was prepared by introducing Example 2, Comparative Example 1, and a commercially available electrolyte layer (Celgard).

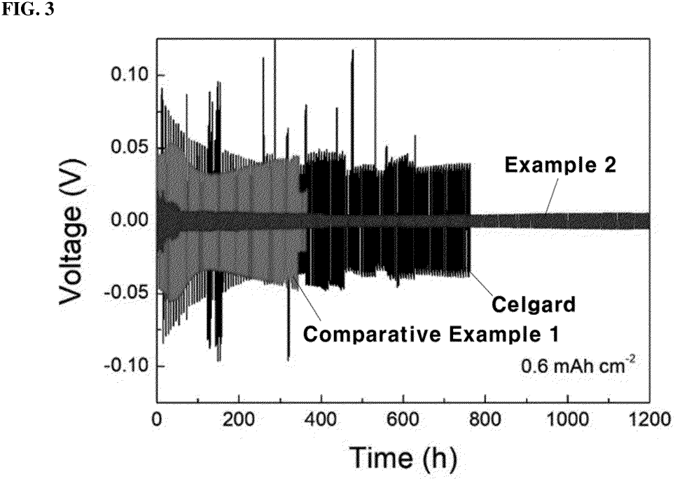

FIG. 3 shows a galvanostatic cycling voltage profile of each symmetric cell. Referring to this, it can be seen that the symmetric cell of Example 2 has the longest lifespan and is electrochemically stable.

### Experimental Example 4

A lithium metal battery having a stacked structure of Li/electrolyte layer/LFP was prepared by introducing Example 2 and a commercially available electrolyte layer (Celgard).

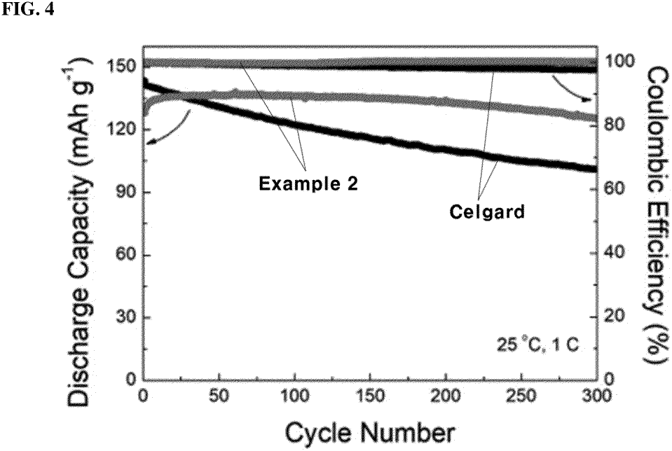

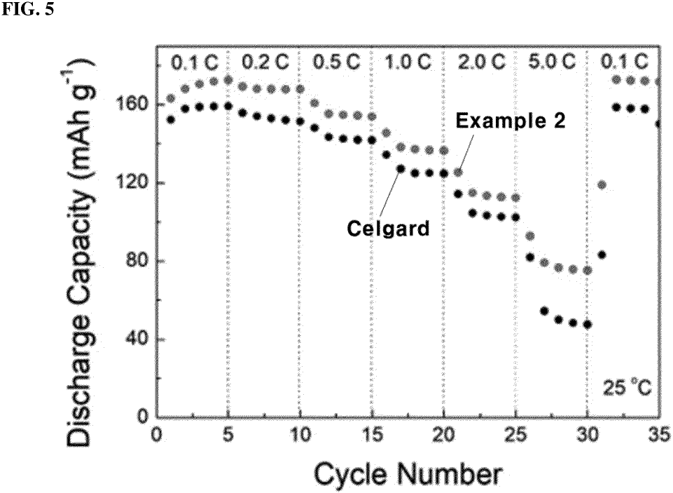

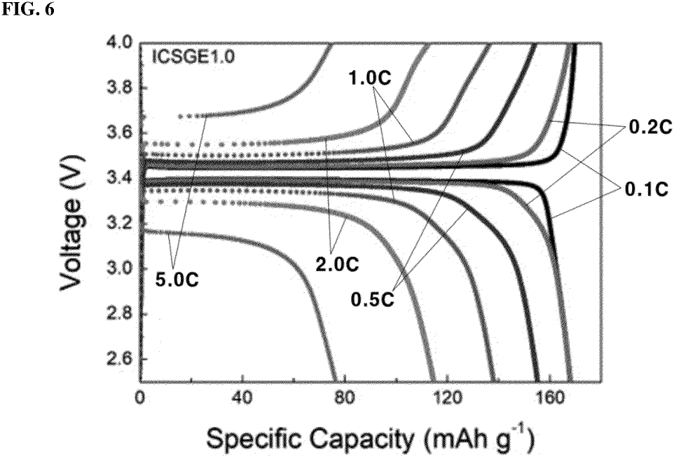

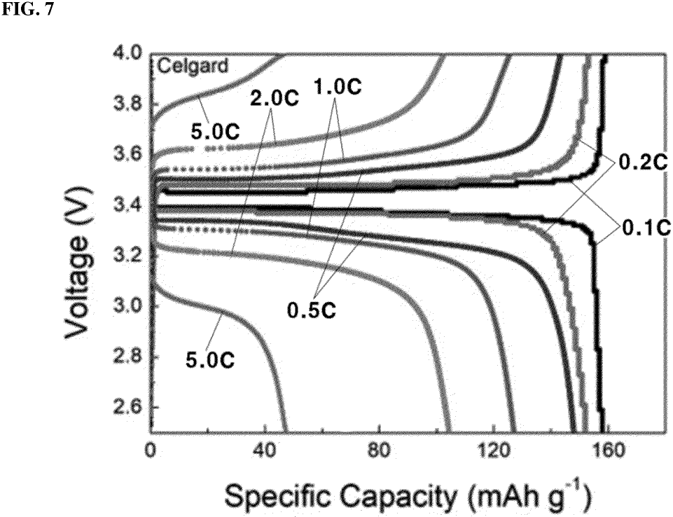

FIG. 4 shows discharge capacities and coulombic efficiencies of the respective lithium metal batteries. FIG. 5 shows C rate capacity test results for discharge capacities of the respective lithium metal batteries. FIG. 6 shows a result of evaluating capacity properties of a lithium metal battery according to Example 2. FIG. 7 shows a result of evaluating capacity properties of a lithium metal battery to which a commercially available electrolyte layer (Celgard) is introduced.

Referring to these figures, it can be seen that the lithium metal battery to which the electrolyte layer according to Example 2 is applied is excellent in both lifespan and capacity properties.

Although various examples have been described with reference to the limited Examples and drawings as described above, various modifications and variations are possible from the above description by one of ordinary skill in the art. For example, appropriate results can be achieved although described techniques are performed in an order different from a described method, and/or described elements are joined or combined in a form different from the described method, or replaced or substituted by other elements or equivalents. Therefore, other examples, variations, modifications, and equivalents to the scope of claims also belong to the scope of the claims to be described later.

What is claimed is:

1. A composition for a gel polymer electrolyte, comprising:
a fluorine-based compound;
a lithium salt; and
a crosslinking agent comprising a graphene-based compound.

2. The composition of claim 1, wherein the fluorine-based compound comprises at least one of: poly(vinylidene fluoride-co-hexafluoropropylene) (PVDF-HFP), a perfluorinated sulfonic acid-based polymer, or any combination thereof.

3. The composition of claim 1, wherein the lithium salt comprises at least one of: lithium 1-(3-(methacryloyloxy)propylsulfonyl)-1-(trifluoromethanesulfonyl)imide (LiMTFSI), lithium(4-styrenesulfonyl)(trifluoromethanesulfonyl)imide (LiSTFSI), or any combination thereof.

4. The composition of claim 1, wherein the graphene-based compound comprises a graphene oxide surface-modified with methacrylate.

5. The composition of claim 1, wherein the fluorine-based compound and the lithium salt have a mass ratio of about 1:0.1 to 1:10.

6. The composition of claim 1, wherein the composition comprises:
an amount of more than about 98% by weight and less than about 100% by weight of the fluorine-based compound and the lithium salt; and
an amount of more than about 0% by weight and less than about 2% by weight of the crosslinking agent.

7. The composition of claim 1, wherein the composition further comprises an initiator, and the initiator comprises at least one of: benzoyl peroxide, acetyl peroxide, dilauroyl peroxide, di-tert-butyl peroxide, t-butyl peroxy-2-ethylhexanoate, cumyl hydroperoxide, hydrogen peroxide, 2,2-azobis(2-cyanobutane), 2,2′-azobis(2-methylbutyronitrile), azobisisobutyronitrile (AIBN), azobisdimethyl-valeronitrile (AMVN), or any combination thereof.

8. A lithium secondary battery comprising:
a cathode layer;
an anode layer; and
an electrolyte layer interposed between the cathode layer and the anode layer,
wherein the electrolyte layer comprises a gel polymer electrolyte, and the gel polymer electrolyte comprises a porous membrane in which a fluorine-based compound, a lithium salt, and a crosslinking agent comprising a graphene-based compound are crosslinked.

9. The lithium secondary battery of claim 8, wherein the fluorine-based compound comprises at least one of: poly(vinylidene fluoride-co-hexafluoropropylene) (PVDF-HFP), a perfluorinated sulfonic acid-based polymer, or any combination thereof.

10. The lithium secondary battery of claim 8, wherein the lithium salt comprises at least one of: lithium 1-(3-(methacryloyloxy)propylsulfonyl)-1-(trifluoromethanesulfonyl)imide (LiMTFSI), lithium(4-styrenesulfonyl)(trifluoromethanesulfonyl)imide (LiSTFSI), or any combination thereof.

11. The lithium secondary battery of claim 8, wherein the graphene-based compound comprises a graphene oxide surface-modified with methacrylate.

12. The lithium secondary battery of claim 8, wherein the fluorine-based compound and the lithium salt have a mass ratio of about 1:0.1 to 1:10.

13. The lithium secondary battery of claim 8, wherein the gel polymer electrolyte comprises:
an amount of more than about 98% by weight and less than about 100% by weight of the fluorine-based compound and the lithium salt; and
an amount of more than about 0% by weight and less than about 2% by weight of the crosslinking agent.

14. The lithium secondary battery of claim 8, wherein the electrolyte layer further comprises a liquid electrolyte impregnated in the gel polymer electrolyte.

15. A method for manufacturing a gel polymer electrolyte, the method comprising:
preparing a solution comprising a fluorine-based compound, a lithium salt, and a crosslinking agent comprising a graphene-based compound;
preparing a reactant by adding an initiator into the solution; and
applying the reactant onto a substrate and performing in-situ crosslinking.

16. The method of claim 15, wherein the fluorine-based compound comprises at least one of: poly(vinylidene fluoride-co-hexafluoropropylene) (PVDF-HFP), a perfluorinated sulfonic acid-based polymer, or any combination thereof.

17. The method of claim 15, wherein the lithium salt comprises at least one of: lithium 1-(3-(methacryloyloxy)propylsulfonyl)-1-(trifluoromethanesulfonyl)imide (LiMTFSI), lithium(4-styrenesulfonyl)(trifluoromethanesulfonyl)imide (LiSTFSI), or any combination thereof.

18. The method of claim 15, wherein the graphene-based compound comprises a graphene oxide surface-modified with methacrylate.

19. The method of claim 15, wherein the fluorine-based compound and the lithium salt have a mass ratio of about 1:0.1 to 1:10.

20. The method of claim 15, wherein the solution comprises:
an amount of more than about 98% by weight and less than about 100% by weight of the fluorine-based compound and the lithium salt; and
an amount of more than about 0% by weight and less than about 2% by weight of the crosslinking agent.
